(19) United States
(12) Patent Application Publication
(10) Pub. No.: US 2025/0138991 A1
(43) Pub. Date: May 1, 2025

(54) DARWINIAN ELO FRAMEWORKS FOR CHATBOT EVALUATION

(71) Applicant: NIKHIL SHARMA, San Francisco, CA (US)

(72) Inventor: NIKHIL SHARMA, San Francisco, CA (US)

(21) Appl. No.: 18/531,540

(22) Filed: Dec. 6, 2023

Related U.S. Application Data
(60) Provisional application No. 63/545,820, filed on Oct. 26, 2023.

(51) Int. Cl. G06F 11/36

(52) U.S. Cl. CPC G06F 11/3696

(57) ABSTRACT

In one aspect, a computerized method for Darwinian Elo frameworks for chatbot evaluation comprising: implementing an ad-hoc development testing, wherein the ad-hoc development testing comprises a first phase of chatbot evaluation; implementing a response generation, wherein once a model version used for response generation is ready by flagging the model version for evaluation arena candidacy; implementing a simulated Elo evaluation, wherein once one or more generations of models are generated for the candidate model, each candidate model is evaluated in a simulated evaluation arena, and wherein each of the one or more generations of models undergo regular matches against one another; and implementing a live Elo evaluation, wherein a set of top models are used in a live environment.

### CLAIM OF PRIORITY

This application claims priority to U.S. Patent Application No. 63/545,820, filed on 26 Oct. 2023 and titled DARWINIAN ELO FRAMEWORKS FOR CHATBOT EVALUATION. This provisional application is hereby incorporated by reference in its entirety.

### BACKGROUND

Evaluation of large-language models (LLMs) is typically a difficult problem to be solved. Unlike traditional supervised learning problems, there isn't a widely accepted way to quantify and thus iteratively improve model quality.

Recently, there have been a number of different approaches tried for evaluating different types of models, including using n-gram metrics (e.g. BLEU, ROUGE, etc.), using off-the-shelf LLMs to evaluate custom LLM chains with domain-specific retrieval-augmented generation (RAG), and creating Elo-based frameworks for comparative evaluation. Many of these approaches have significant limitations or challenges.

### SUMMARY OF THE INVENTION

In one aspect, a computerized method for Darwinian Elo frameworks for chatbot evaluation comprising: implementing an ad-hoc development testing, wherein the ad-hoc development testing comprises a first phase of chatbot evaluation; implementing a response generation, wherein once a model version used for response generation is ready by flagging the model version for evaluation arena candidacy; implementing a simulated Elo evaluation, wherein once one or more generations of models are generated for the candidate model, each candidate model is evaluated in a simulated evaluation arena, and wherein each of the one or more generations of models undergo regular matches against one another; and implementing a live Elo evaluation, wherein a set of top models are used in a live environment.

### BRIEF DESCRIPTION OF THE DRAWINGS

FIG. 1 illustrates an example process for Darwinian Elo Frameworks for Chatbot Evaluation, according to some embodiments.

FIG. 2 illustrates an example process that can be utilized for triggering chatbot evaluation via a Darwinian Elo Framework, according to some embodiments.

FIG. 3 illustrates an example process that can be utilized for response generation and evaluation, according to some embodiments.

FIG. 4 illustrates an example process that can be utilized for Simulated Elo evaluation, according to some embodiments.

FIG. 5 illustrates an example process that can be utilized for Live Elo evaluation, according to some embodiments.

FIG. 6 illustrates an example load-balancing process, according to some embodiments.

FIG. 7 illustrates an example table of rule-based evaluator decisions, according to some embodiments.

FIG. 8 illustrates an example process for a live evaluation arena with a rule-based evaluator, according to some embodiments.

FIG. 9 illustrates an example process for Darwinian ELO frameworks for chatbot evaluation, according to some embodiments.

FIG. 10 is a block diagram of a sample computing environment that can be utilized to implement various embodiments.

The Figures described above are a representative set and are not exhaustive with respect to embodying the invention.

### DESCRIPTION

Disclosed are a system, method, and article of manufacture for Darwinian Elo Frameworks for Chatbot Evaluation. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Artificial intelligence art is any visual artwork created through the use of artificial intelligence (AI) programs.

Application program is a computer program designed to carry out a specific task other than one relating to the operation of the computer itself and can be used by end-users.

Chatbot can be a software application and/or web interface that mimics human conversation through various interactions (e.g. text or voice, etc.). A chatbot can use AI systems that are capable of maintaining a conversation with a user in natural language and simulating the way a human would behave as a conversational partner. Chatbots can utilize aspects of deep learning and natural language processing.

Chatbot Arena is an open-source research project developed that can be used to create an open crowdsourced platform to collect human feedback and evaluate LLMs under real-world scenarios. It is noted that other similar systems can be used in other example embodiments.

CI/CD or CICD is the combined practices of continuous integration (CI) and continuous delivery (CD).

Generative Pre-trained Transformer 4 (GPT-4) is a multimodal large language model created by OpenAI, and the fourth in its numbered “GPT-n” series of GPT foundation models. As a transformer-based model, GPT-4 was pretrained to predict the next token (e.g. using both public data and data licensed from third-party providers) and was then fine-tuned with reinforcement learning from human and AI feedback for human alignment and policy compliance. It is noted that other multimodal large language models can be utilized in other example embodiments.

Deep learning is part of a broader family of machine learning methods based on artificial neural networks with representation learning. Learning can be supervised, semi-supervised or unsupervised.

Deep neural network (DNN) is an artificial neural network (ANN) with multiple layers between the input and output layers. There are different types of neural networks, but they always consist of the same components: neurons, synapses, weights, biases, and functions.

Elo rating system is a method for calculating the relative skill levels of players in zero-sum games.

Large language model (LLM) is a language model characterized by emergent properties enabled by its large size. An LLM can be built with artificial neural networks. These can be pre-trained. The training can utilize self-supervised learning and/or semi-supervised learning. For example, artificial neural networks can contain tens of millions to billions of weights. The LLMs can be trained using a specialized AI accelerator hardware to parallel process vast amounts of text data, mostly scraped from the Internet. As language models, they work by taking an input text and repeatedly predicting the next token or word.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, logistic regression, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Retrieval Augmented Generation (RAG) can augment an LLM with document retrieval (e.g. using a vector database). In one example, given a query, a document retriever is called to retrieve the most relevant (e.g. measured by first encoding the query and the documents into vectors, then finding the documents with vectors closest in Euclidean norm to the query vector). The LLM can then generate an output based on both the query and the retrieved documents.

Vicuna is an open-source chatbot that can include the strengths of two models: LLaMa from Meta and Alpaca from Stanford. Vicuna can be used for fine-tuning LLaMa. This fine-tuning process enhances Vicuna's ability to understand and respond to user inputs effectively. It is noted that Vicuna is provided by way of example and other similar systems can be used in other example embodiments.

These systems and functions can be incorporated into various embodiments discussed herein.

### Example Systems and Methods

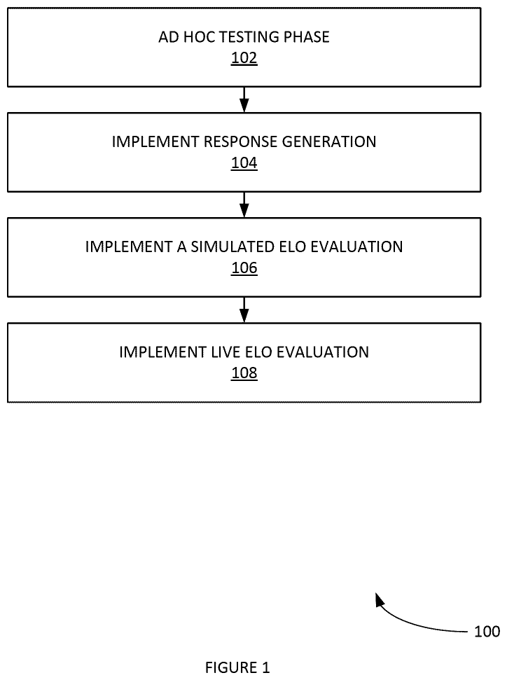

FIG. 1 illustrates an example process 100 for Darwinian Elo Frameworks for Chatbot Evaluation, according to some embodiments.

Process 100 uses a Darwinian “survival-of-the-fittest” style evaluation framework based on Elo scoring to comparatively evaluate agents, across both simulated and live environments. Process 100 can be entirely automated with no human-in-the-loop necessary and can be seamlessly integrated into CI/CD workflows and other automated testing and quality assurance processes. Process 100 can define an automated evaluation arena for chatbots.

An example model lifecycle is now described. Process 100 can use the following Framework Parameters:
M—the number of models that can be active in the evaluation arena at any given point;
P—the number of prompts used to generate a corpus of generations for a new model before entry into the arena;
K—the minimum number of matches a new model is allowed on staging in order to get an initial Elo rating. These are called “provisional matches”;
L—the number of additional uniform matches scheduled across all arena models. These are called “smoothing matches”;
W—the epoch window size used during live-testing; and
u—The minimum number of epochs a new model is permitted in the live-testing environment.

In step 102, process 100 implements Ad-hoc Development Testing. In a Lifecycle Stage 0, the ad-hoc testing phase is the first phase in evaluation. During development, a model's parameters may undergo several iterations with small changes via fine-tuning, prompt engineering, etc.

In step 104, process 100 can implement response generation. Once a model version is ready, flag the model version for evaluation arena candidacy. This can be triggered automatically via CI/CD pipelines. For example, if a new model version is pushed to a model registry and/or a new set of prompt configurations are added. For each of our P curated prompts for evaluation, the new model version that is pushed will be prompted to generate a response. These responses can be managed in a document database.

Basically, the new chatbot should have held enough synthetic conversations and/or synthetic responses to a standardized set of questions where its responses can be compared to the responses from other chatbots to the same standardized set of questions. Once this dataset is created for the new chatbot, it's considered “ready”.

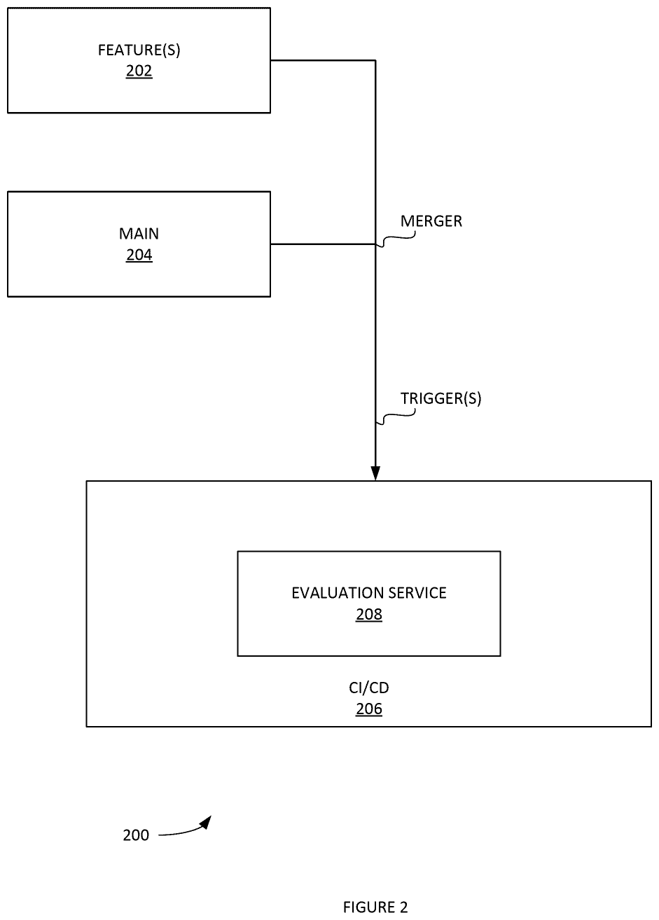

FIG. 2 illustrates an example process 200 that can be utilized for triggering chatbot evaluation via a Darwinian Elo Framework, according to some embodiments. Feature(s) 202 elements can be code deltas to be applied as an update to the main elements. Main elements 204 can be the state of the code, GPT prompts, and/or model weights used for generating chatbot responses. Evaluation service 208 can be a process able to determine the comparative quality of outputs from different chatbots' generations. CI/CD 206 can be a continuous integration (CI) and continuous delivery (CD) process. Process 200 can be used to automatically and continuously evaluate groups of chatbots based on generation quality, and deploy the best-performing ones for usage in the wild.

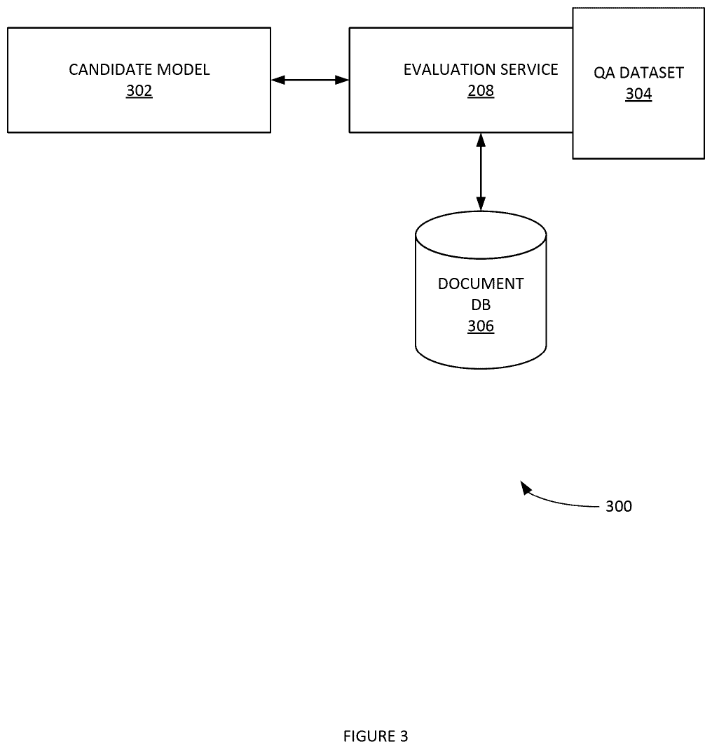

FIG. 3 illustrates an example process 300 that can be utilized for response generation and evaluation, according to some embodiments. Candidate model 302 can be a chatbot model able to generate responses to queries. QA dataset 304 can be a mapping between queries and generated responses by different chatbot models. Document DB 306 can be the database used for QA dataset storage and management. Process 300 can be used to prepare a chatbot for evaluation by generating responses to a standardized set of queries.

In step 106, process 100 can implement a simulated Elo evaluation. Once one or more generations are generated for the candidate model, the process can evaluate it in a simulated evaluation arena (e.g. a “staging” operation). Models on staging undergo regular matches against one another, with matches defined as is now discussed.

A match involves two models. A random prompt from our P prompts is selected, and the generation (which was generated in Stage 1 above) from each model for this prompt is passed to an off-the-shelf LLM such as GPT-4 (e.g. the “judge model” henceforth) along with a prompt to evaluate which response is better. This prompt can adhere to the following basic structure:

System Directive—A clause that instructs the judge model to evaluate the two prompts holistically across several criteria such as accuracy, brevity, coherence, etc. based on the specific goals of the application for which you are evaluating. This section can contain specifics about how to weigh each criteria, and how to combine them to determine an ultimate match winner;

Generation Contexts—A clause that contains the initial prompt as well as the two generations for the two competing models. These will be delineated appropriately; and

Ending—This can involve an incomplete statement which the judge model will complete. Perhaps something like “Based on the above criteria, the final winner is:”. Optionally, this might include additional prompting to provide an explanation for extra manual validation of correct behavior.

On staging, process 100 can allow the new candidate model to participate in K provisional matches with the existing M baseline models. The candidate model starts with an initial rating, which can be selected depending on the use case. For example, one apt choice might be to set the initial rating equal to the minimum rating of the existing models in the evaluation arena.

Each of the K provisional matches involves the candidate model, one of the other M models and one of the P prompts are sampled as per a sampling policy. For example, one reasonable choice might be to sample the other model uniformly at random with replacement from the M existing models, and the prompt uniformly at random without replacement from the P prompts.

After K provisional matches are complete, process 100 performs L smoothing matches. These are identical to the provisional matches, except that both models in the match are selected as per a sampling policy rather than fixing one of them to be the new candidate model.

At the end of the K+L matches, the lowest-rated model on our model leaderboard is deprecated, leaving us once again with only M models. Based on performance, perhaps the candidate model has outperformed and thus replaced one of the baseline models.

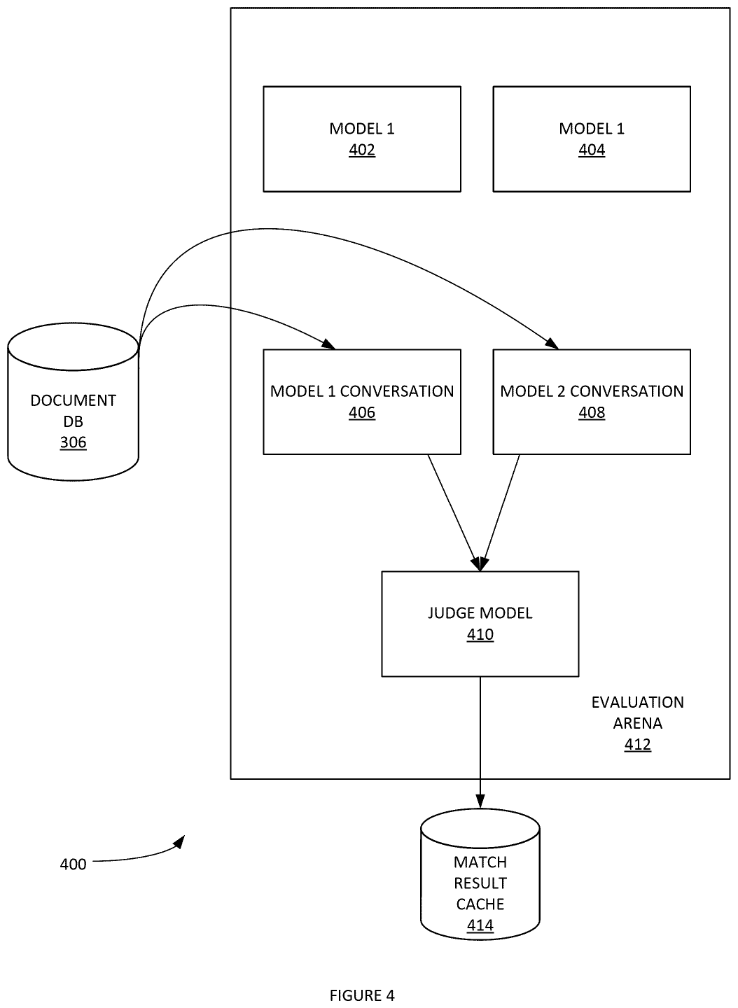

FIG. 4 illustrates an example process 400 that can be utilized for Simulated Elo evaluation, according to some embodiments. Model 1 402 can be a chatbot model. Model 2 404 can be another chatbot model. Model 1 conversation 406 can be a conversation between two parties, one of which responded via generations from Model 1. Model 2 conversation 408 can be a conversation between two parties, one of which responded via generations from Model 2. Judge model 410 can be an artificial intelligence model used for selecting a preferred conversation between Model 1 conversation and Model 2 conversation, as per some provided criteria. Document DB 306 can be the database used for storage and management of Model 1 conversations, Model 2 conversations, and evaluation results between pairs of conversation as per the Judge model. Evaluation arena 412 can be described as the holistic process of retrieving two conversations from two Models and comparing them via the Judge model. Process 400 shows this process of holistic comparison between synthetic conversations from pairs of models.

In step 108, process 100 can implement Live Elo Evaluation. The top M models are used in a live environment (e.g. a “production” stage). Updates to which models are used can happen as per any policy—for example, each time a new candidate model replaces an existing baseline model, on manual trigger, etc.

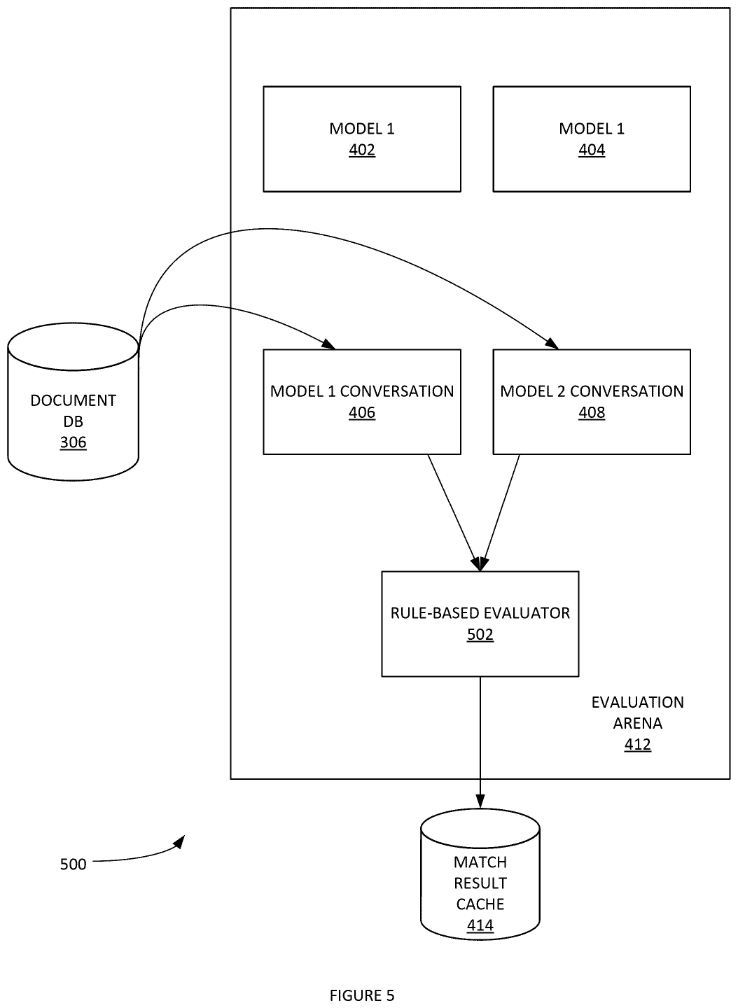

FIG. 5 illustrates an example process 500 that can be utilized for Live Elo evaluation, according to some embodiments. Rule-based evaluator 502 can be a deterministic policy for selecting a preferred conversation between Model 1 conversation and Model 2 conversation, as per some provided criteria. Process 500 shows the process of holistic comparison between real conversations from pairs of models.

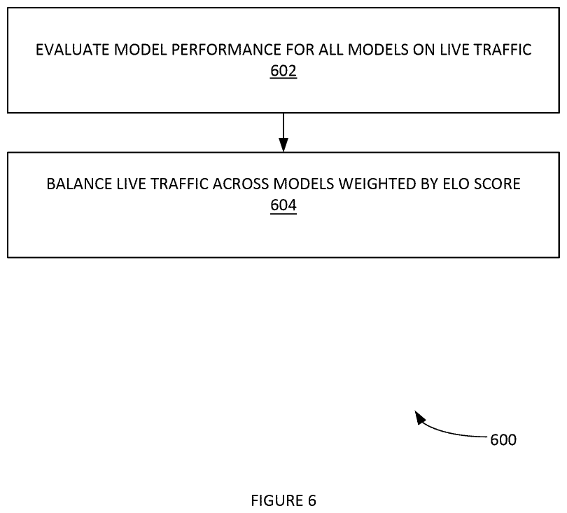

Traffic can be load balanced on production across all the M models. Process 100 can achieve, inter alia, two goals with this load balancing. FIG. 6 illustrates an example load-balancing process 600, according to some embodiments.

In step 602, process 600 can evaluate model performance for all models on live traffic.

In step 604, process 600 can balance live traffic across models weighted by ELO score. This can include providing good generations, as this is a live environment that handles real user traffic.

An example embodiment of a proposed load balancing algorithm and rationale in the “Are there any algorithms performed by the system?” section below. Assuming for now that this load balancing algorithm which satisfies our two goals exists, let's now proceed by describing production evaluations.

On production, process 100 can extract feedback from real engagement with a chatbot. For this, two additional primitives can be defined as follows:
1. Conversation Starters: Conversation starters are application-specific entry points that trigger a chatbot conversation. As an example, on an ecommerce website, a user might be initially prompted to select if you want to chat about (1) product recommendations, (2) product returns, (3) active sales and promotions, and each option may send a different introductory message that kicks off the conversation.
2. Conversation Goals: These are once again application-specific, but process 100 can provide a couple of guiding examples. A goal might be to have a user have a positive experience, which can be measured by including a “Did you enjoy your conversation today (thumbs up), (thumbs down)” closing message. A more complex goal might be to obtain the user's email address during the conversation. Goals can be constructed such that for a conversation their success can be marked as “yes”, “no”, or “indeterminate/inapplicable”. After the close of each epoch window of size W, process 100 can perform a rating re-evaluation based on conversations. For this, process can perform a similar type of sampling for matches, where results are based on goal success.

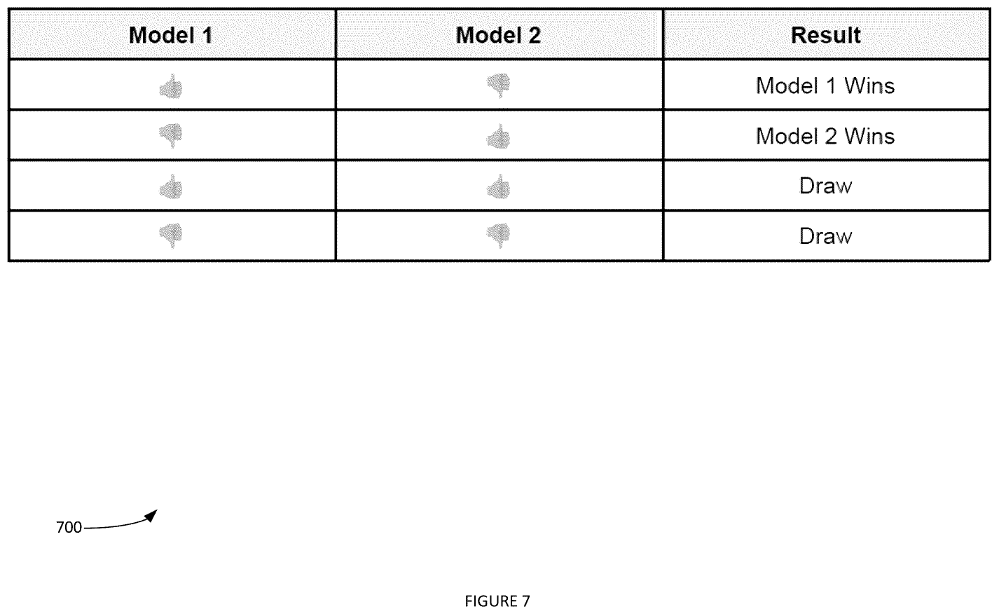

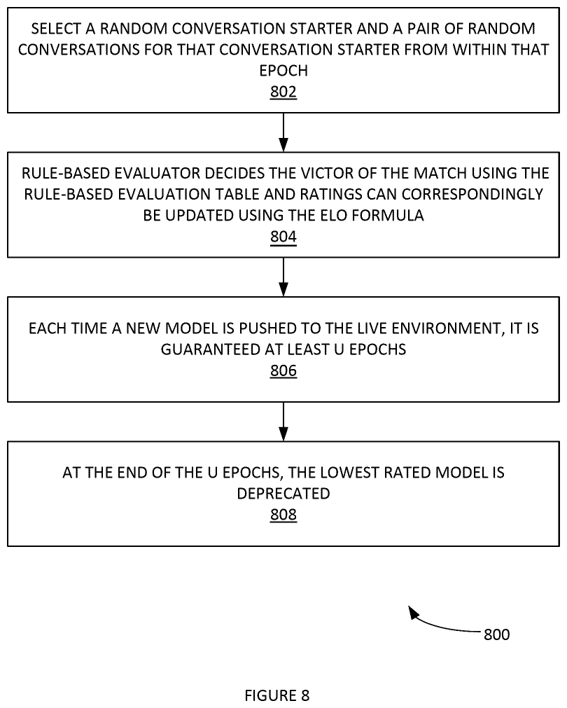

Process 100 can schedule matches in the live evaluation arena in a similar manner. FIG. 8 illustrates an example process 800 for live evaluation arena with a rule-based evaluator, according to some embodiments. This can be performed with a rule-based evaluator. In step 802, process 800 selects a random conversation starter and a pair of random conversations for that conversation starter from within that epoch. In step 804, a rule-based evaluator decides the victor of the match using the rule-based evaluation table and ratings can correspondingly be updated using the Elo formula. In step 806, each time a new model is pushed to the live environment, it is guaranteed at least u epochs (for a total guaranteed live evaluation window of size uW). At the end of the u epochs, similarly, to staging, the lowest rated model is deprecated in step 808. FIG. 7 illustrates an example table of rule-based evaluator decisions, according to some embodiments.

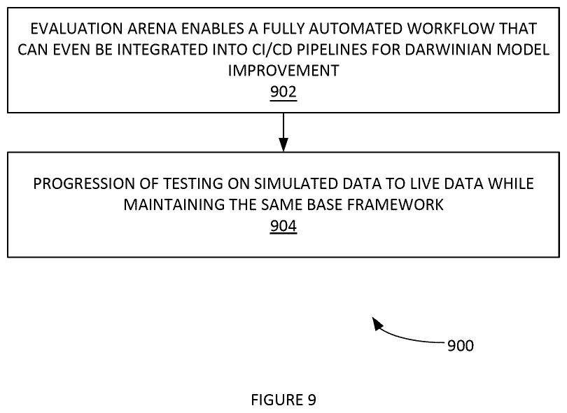

FIG. 9 illustrates an example process 900 for Darwinian ELO frameworks for chatbot evaluation, according to some embodiments. Firstly, in step 902, the evaluation arena enables a fully automated workflow that can even be integrated into CI/CD pipelines for Darwinian model improvement. Secondly, in step 904, the progression of testing on simulated data to live data while maintaining the same base framework.

As mentioned in the background section, there have been attempts to rank models with Elo scores (e.g. Chatbot Arena and/or other similar systems, etc.), and also attempts to use an off-the-shelf LLM for evaluation (e.g. Vicuna and/or other similar systems, etc.). Another recent result also shows that AI evaluation shows no performance degradation when compared to human evaluation for comparing responses to two questions. Process 900 can augment these results in a few distinctive ways, inter alia: combine the approach of comparative ranking via Elo ratings with off-the-shelf LLM evaluation for an entirely hands-off approach to evaluating model versions; introduces a novel Darwinian “survival-of-the-fittest” policy algorithm for evaluation in both a provisional simulated testing and a live testing situation.

An example load balancing algorithm used in our proposed live environment is now provided. Models, as discussed in other sections, have an Elo rating. Higher ratings correspond to higher probability of selection. The Elo formula dictates that the following formula can be used to compute expected win percentage of a higher rated model A over a lower rated model B:E(A>B)=1/(1+10**(R_B−R_A)/400) or to put this into context, a 100 point difference indicates a 64% win rate and a 200 point difference indicates an expected 76% win rate. We propose setting selection probabilities in our load balancer such that they scale with expected win rate. That is, a 100-point rating difference means a selection probability that's 76% greater.

This can be achieved with the following algorithm: Step 1: Compute Summed Expected Win Rates For each model Ai compute E(Ai>Aj) for all j≠i. Then sum up these values. That is, find S(Ai)=sum(E(Ai>Aj); j≠i and 1<=j<=M) Step 2: Normalize Once all of the summed expected win rates are computed for each model, normalize these to get a probability distribution. These are the weighted sampling rates that our load balancer should use to maintain the desired condition. Specifically, to normalize we can compute the selection probability pi for a model as pi=S(Ai)/sum(S(Aj); 1<=j<=M).

### Additional Example Computer Architecture and Systems

A Machine learning (ML) module can be provided and can implement various optimizations and models related to training the various AI models used herein. ML a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. If the data in the test dataset has never been used in training (e.g. in cross-validation), the test dataset is also called a holdout dataset.

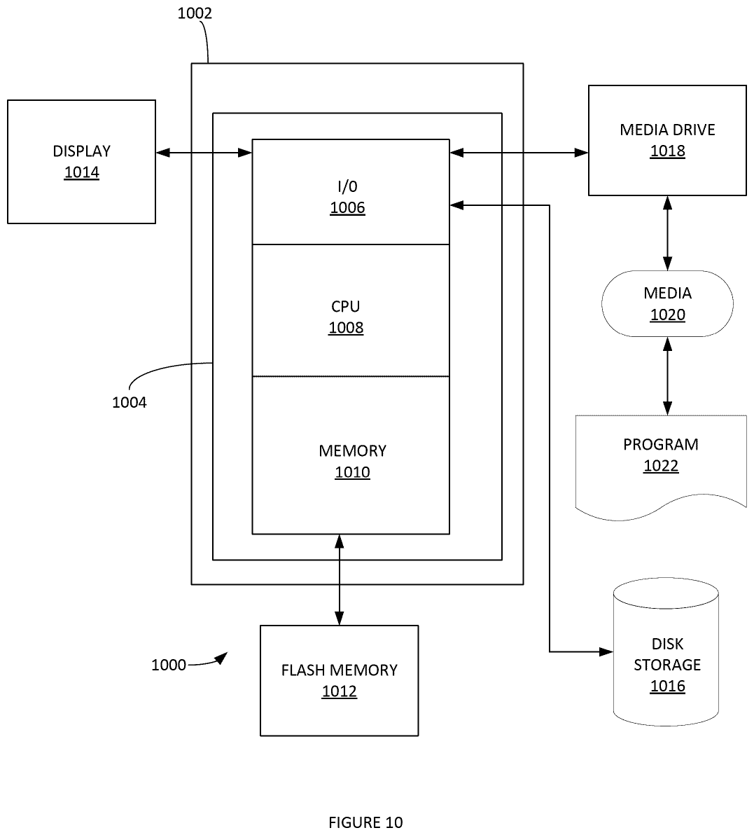

FIG. 10 depicts an exemplary computing system 1000 that can be configured to perform any one of the processes provided herein. In this context, computing system 1000 may include, for example, a processor, memory, storage, and I/O devices (e.g., monitor, keyboard, disk drive, Internet connection, etc.). However, computing system 1000 may include circuitry or other specialized hardware for carrying out some or all aspects of the processes. In some operational settings, computing system 1000 may be configured as a system that includes one or more units, each of which is configured to carry out some aspects of the processes either in software, hardware, or some combination thereof.

FIG. 10 depicts computing system 1000 with a number of components that may be used to perform any of the processes described herein. The main system 1002 includes a motherboard 1004 having an I/O section 1006, one or more central processing units (CPU) 1008, and a memory section 1010, which may have a flash memory card 1012 related to it. The I/O section 1006 can be connected to a display 1014, a keyboard and/or other user input (not shown), a disk storage unit 1016, and a media drive unit 1018. The media drive unit 1018 can read/write a computer-readable medium 1020, which can contain programs 1022 and/or data. Computing system 1000 can include a web browser. Moreover, it is noted that computing system 1000 can be configured to include additional systems in order to fulfill various functionalities. Computing system 1000 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A computerized method for Darwinian Elo frameworks for chatbot evaluation comprising:
implementing an ad-hoc development testing, wherein the ad-hoc development testing comprises a first phase of chatbot evaluation;
implementing a response generation, wherein once a model version used for response generation is ready by flagging the model version for evaluation arena candidacy;
implementing a simulated Elo evaluation, wherein once one or more generations of models are generated for the candidate model, each candidate model is evaluated in a simulated evaluation arena, and wherein each of the one or more generations of models undergo regular matches against one another; and
implementing a live Elo evaluation, wherein a set of top models are used in a live environment.

2. The computerized method of claim 1, wherein the flagging the model version for evaluation arena candidacy is triggered automatically via a plurality of CI/CD pipelines.

3. The computerized method of claim 2, wherein a new model version is pushed to a model registry and a new plurality of prompt configurations are added.

4. The computerized method of claim 3, wherein for each of a plurality of curated prompts for evaluation, a new model version is pushed and is prompted to generate a response.

5. The computerized method of claim 4, wherein the responses are managed in a document database.

6. The computerized method of claim 5, wherein the wherein each of the one or more generations of models undergo at least one match against one another.

7. The computerized method of claim 6, wherein the at least one match is defined by:
wherein a match involves two models,
wherein a random prompt from our P prompts is selected, and the generation from each model for this prompt is passed to an LLM along with a prompt to evaluate which response is better.

8. The computerized method of claim 7, wherein the LLM comprises a GPT-4 LLM as a judge model.

9. The computerized method of claim 8, wherein each of the K provisional matches comprises the candidate model, one of the other models and one of the prompts that are sampled as per a sampling policy.

10. The computerized method of claim 9, wherein after the provisional matches are complete, performing a smoothing match.

11. The computerized method of claim 10, wherein at the end of a specified number of matches, a lowest-rated model on a model leaderboard is deprecated, leaving with a preset number of models.

12. The computerized method of claim 11, wherein based on a specified performance metric, determines that the candidate model has outperformed a set of other models.

13. The computerized method of claim 12, wherein one of the baseline models is replaced by the candidate model.

14. The computerized method of claim 12, wherein an update to which one or more models are used is performed per a specified policy comprising each time a new candidate model replaces an existing baseline model or based on a manual trigger.
